(19) United States
(12) Patent Application Publication
(10) Pub. No.: US 2023/0299329 A1
(43) Pub. Date: Sep. 21, 2023

(54) SOLID-STATE BATTERY AND METHOD FOR MAKING THE SAME

(71) Applicant: HONDA MOTOR CO., LTD., Tokyo (JP)

(72) Inventors: Takuya TANIUCHI, Saitama (JP); Masahiro OHTA, Saitama (JP)

(21) Appl. No.: 18/321,793

(22) Filed: May 23, 2023

Related U.S. Application Data
(63) Continuation of application No. 17/105,645, filed on Nov. 27, 2020.

(30) Foreign Application Priority Data
Dec. 17, 2019 (JP) 2019-227244

(51) Int. Cl. H01M 10/04; H01M 10/0585; H01M 50/116; H01M 50/30

(52) U.S. Cl. CPC H01M 10/0468; H01M 10/0585; H01M 50/116; H01M 50/394

(57) ABSTRACT

To provide a solid-state battery capable of applying an initial load that results in sufficient surface pressure to a battery cell, and a method for making the solid-state battery.

A pressing part is provided in the solid-state battery case and the force of the spring is utilized, and a gas vent port is provided to replace gas or perform depressurization.

Specifically, a solid-state battery including a solid-state battery cell and a battery case that houses the solid-state battery cell, is provided. A pressing part that applies surface pressure to the solid-state battery cell is formed on a surface constituting the battery case that is substantially perpendicular to the laminating direction of a laminate constituting the solid-state battery cell, and at least one gas vent port is formed in the battery case.

This application is a continuation application of U.S. patent application Ser. No. 17/105,645, filed Nov. 27, 2020, which claims the benefit of priority from Japanese Patent Application No. 2019-227244, filed on 17 Dec. 2019, the content of which is incorporated herein by reference.

### BACKGROUND OF THE INVENTION

### Field of the Invention

The present invention relates to a solid-state battery and a method for making the same.

Further, the present invention relates to a solid-state battery having large output characteristics and a method for making the same.

### Related Art

Conventionally, as secondary batteries having a high energy density, lithium ion secondary batteries are widely used.

The lithium ion secondary battery has a structure in which a separator is present between a positive electrode and a negative electrode, and the battery cell is filled with a liquid electrolyte (electrolyte solution).

Since the electrolyte solution of such a lithium ion secondary battery is usually a flammable organic solvent, some lithium ion secondary batteries pose a safety issue of heat, in particular.

Therefore, solid-state batteries employing an inorganic solid electrolyte as an alternative to the organic liquid electrolyte have also been proposed (see Patent Document 1). A solid-state battery employing a solid electrolyte can resolve the issue of heat, can increase the capacity and/or the voltage by lamination, and can further meet the need for compactness, compared to a battery employing an electrolyte solution.

Herein, in the case of a lithium ion secondary battery including a liquid electrolyte, the battery cell is filled with the electrolyte solution after the battery cell is inserted into the battery case, and thus the battery cell expands by the electrolyte solution.

Subsequently, initial charge and discharge and aging cause the volume of the battery cell to expand, and thus the battery case and the battery cell come into close contact with each other, and surface pressure is applied.

However, in a solid-state battery including a solid electrolyte, since the volume expansion of the battery cell is less after the battery cell is inserted into the battery case, sufficient surface pressure to the battery is not generated.

This results in an increase in interfacial resistance and a decrease in input-output characteristics.

In response, it is known that output characteristics can be improved by heating a solid-state battery and applying a load.

Patent Document 1: Japanese Unexamined Patent Application, Publication No. 2000-106154

### SUMMARY OF THE INVENTION

The present invention has been made in view of the above-mentioned background art, and an object thereof is to provide a solid-state battery capable of applying an initial load that results in sufficient surface pressure to the battery cell, and a method for making the solid-state battery.

The present inventors have focused on the fact that, unlike a lithium ion secondary battery which is filled with a liquid electrolyte, a solid-state battery including a solid electrolyte has less volume expansion of the battery cell after the battery cell is inserted into the battery case, and therefore, the insertion clearance remains in the battery case and the battery cell even after aging of the solid-state battery, so that surface pressure is not sufficiently applied.

Then, the inventors have found that an initial load that results in sufficient surface pressure can be applied to the battery cell by providing a pressing part in the solid-state battery case and utilizing the force of the spring and by providing a gas vent port to replace gas or perform depressurization, to complete the present invention.

That is, the present invention relates to a solid-state battery including a solid-state battery cell and a battery case that houses the solid-state battery cell.

The solid-state battery cell is a laminate including a positive electrode layer, a negative electrode layer, and a solid electrolyte layer present between the positive electrode layer and the negative electrode layer. A surface constituting the battery case that is substantially perpendicular to a laminating direction of the laminate includes a pressing part that applies surface pressure to the solid-state battery cell. The battery case includes at least one gas vent port.

The gas vent port may be closed by a closing member.

The closing member may be metal or a sealing material.

The gas vent port may be formed at a position in contact with a remaining space in the battery case.

One or more grooves serving as gas flow paths may be formed in the pressing part inside the battery case.

At least one of the grooves may pass through a substantially central portion of the pressing part.

At least two said grooves may be formed and disposed substantially perpendicular to each other.

The pressing part may be provided on only one surface of the battery case.

The pressing parts may be provided on a pair of opposed surfaces of the battery case.

The battery case may be metal.

Another aspect of the present invention relates to a method for making a solid-state battery including a solid-state battery cell and a battery case that houses the solid-state battery cell. The solid-state battery cell is a laminate including a positive electrode layer, a negative electrode layer, and a solid electrolyte layer present between the positive electrode layer and the negative electrode layer. A surface constituting the battery case that is substantially perpendicular to a laminating direction of the laminate includes a pressing part that applies surface pressure to the solid-state battery cell. The battery case includes at least one gas vent port. The method includes: an enclosure step of enclosing the solid-state battery cell in the battery case; a depressurization step of depressurizing the interior of the battery case by replacing and/or removing gas in the battery case through the gas vent port; and a closure step of closing the gas vent port with a closing member.

The depressurization step may evacuate the interior of the battery case.

The closure step may close the gas vent port by metal welding or sealing with a sealing material.

The method may further include a heat pressurization treatment step of performing heating and pressurization.

The solid-state battery of the present invention includes the pressing part that utilizes the force of the spring, and the interior of the battery case is depressurized by replacing and/or removing gas in the battery case through the gas vent port, and thereby it is possible to apply an initial load that results in sufficient surface pressure to the battery cell, thus improving the output characteristics of the solid-state battery.

### BRIEF DESCRIPTION OF THE DRAWINGS

FIG. 1 is a cross-sectional view of a solid-state battery according to an embodiment of the present invention;

FIGS. 2A and 2B are diagrams showing a pressing part of a solid-state battery according to an embodiment of the present invention; and

FIGS. 3A and 3B are diagrams showing a pressing part of a solid-state battery according to an embodiment of the present invention.

### DETAILED DESCRIPTION OF THE INVENTION

Embodiments of the present invention will be described below with reference to the drawings.

However, please note that the embodiments described below illustrate the present invention, and the present invention is not limited to the following.

<Solid-State Battery>

The solid-state battery of the present invention includes a solid-state battery cell and a battery case that houses the solid-state battery cell. The solid-state battery cell is a laminate including a positive electrode layer, a negative electrode layer, and a solid electrolyte layer present between the positive electrode layer and the negative electrode layer. A surface constituting the battery case substantially perpendicular to the laminating direction of the laminate has a pressing part, and the battery case has at least one gas vent port.
Hereinafter, each of the components will be described with reference to the drawings.

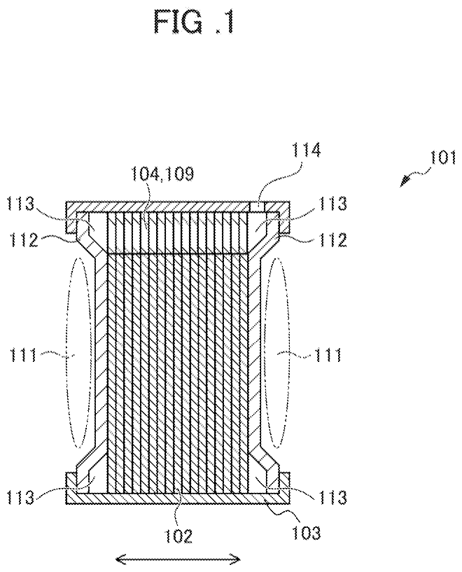

A cross-sectional view of a solid-state battery according to an embodiment of the present invention is shown in FIG. 1.

A solid-state battery 101 shown in FIG. 1 includes a battery cell 102 and a battery case 103 that houses the battery cell 102.
The battery cell 102 has a pressing part 112 and a gas vent port 114 in the battery case 103.

[Battery Case]

### (Gas Vent Port)

The gas vent port in the solid-state battery of the present invention is a hole provided in the battery case, which is used to replace and/or remove gas in the battery case to depressurize the interior of the battery case.
By depressurizing the interior of the battery case, it is possible to apply an initial load that results in sufficient surface pressure to the battery cell, thus improving the output characteristics of the solid-state battery.

At least one said gas vent port is provided in the battery case that houses the solid-state battery cell.

At least one said gas vent port should be provided, and a plurality of said gas vent ports may be provided.
When a plurality of said gas vent ports is provided, it is preferable to place them at diagonal positions in the battery case.

By providing a plurality of said gas vent ports, it is possible to depressurize the interior of the battery case more strongly. Further, by placing a plurality of said gas vent ports at diagonal positions in the battery case, it is possible to apply surface pressure to the battery cell more evenly.

The gas vent port is preferably famed at a position in contact with the remaining space in the battery case.

In the case of a lithium ion secondary battery including a liquid electrolyte, a space is required, in which the battery cell is inserted into the battery case, then filled with the electrolyte solution, and subsequent expansion is taken into consideration. On the other hand, in the case of a solid-state battery, after the battery cell is inserted into the battery case, the volume expansion of the battery cell is less, and thus an unavoidable space remains.

In the present invention, by forming the gas vent port at a position in contact with the remaining space which cannot be avoided in the solid-state battery, the remaining space can be effectively utilized, and the transfer of gas in the battery case can be facilitated.

When the gas vent port is famed at a position in contact with the remaining space in the battery case, it is preferable to form the gas vent port directly below or directly above the remaining space.

By forming the gas vent port directly below or directly above the remaining space, foreign matter generated at the time of sealing the gas vent port can be prevented from contaminating the electrode, and cracking of the electrode due to external force at the time of sealing can be prevented.

In addition, when an insulating material, a buffer material, a moisture absorbent, an adsorbent, or the like is disposed in the remaining space, it is possible to efficiently inject the material through the gas vent port.

The solid-state battery 101 according to the embodiment of the present invention shown in FIG. 1 is an example in which one gas vent port 114 is famed at a position in contact with a remaining space 113 inside the battery case 103.

The gas vent port 114 is famed directly above the remaining space 113. In the solid-state battery 101 shown in FIG. 1, nothing is filled in the remaining space 113, which is a space.
The solid-state battery 101 replaces and/or removes gas in the battery case 103 through the gas vent port 114, thereby depressurizing the interior of the battery case 103.

In the solid-state battery of the present invention, nothing may be disposed, or an insulating material, a buffer material, a moisture absorbent, an adsorbent, or the like may be disposed, in the remaining space inside the battery case.

Although a resin or the like for insulating or fixing the battery cell may be filling the remaining space, it is preferable that nothing is disposed in the region around the gas vent port in the remaining space in contact with the gas vent port, in the step prior to the depressurization step.
Since nothing is disposed in the region, the transfer of the gas in the battery case can be facilitated.

The gas vent port in the solid-state battery of the present invention is preferably closed by a closing member after serving its purpose.

By closing the gas vent port, it is possible to prevent atmospheric ingress and maintain a depressurized state, so that the output characteristics of the solid-state battery can be maintained for a longer period of time.

The closing member for closing the gas vent port is not particularly limited, and examples thereof include metal and a sealing material.

The metal is not particularly limited, and examples thereof include the same metal as that of the case member.

The closing method is also not particularly limited, and examples thereof include welding.

When a sealing material is used as the closing member, the sealing material is not particularly limited, and a known sealing material can be applied.

Examples thereof include silicone sealants.
The sealing method is not particularly limited, and a method suitable for the member can be appropriately selected and applied.

(Pressing Part)

The pressing part of the solid-state battery of the present invention exerts an action of applying surface pressure to the solid-state battery cell by the force of the spring.
For this reason, the pressing part is provided on a surface that is substantially perpendicular to the laminating direction of the laminate of the positive electrode layer, the solid electrolyte layer, and the negative electrode layer in the solid-state battery cell, that is, a surface that is substantially parallel to the positive electrode layer, the solid electrolyte layer, and the negative electrode layer.
Thus, since surface pressure is applied in the laminating direction of the laminate of the positive electrode layer, the solid electrolyte layer, and the negative electrode layer, the initial load can be applied to the battery cell, thereby improving the output characteristics.

The pressing part of the present invention may be provided on only one surface of the battery case, or the pressing parts may be provided on a pair of opposed surfaces.

When the pressing part is provided on only one surface of the battery case, surface pressure is applied only from one side of the laminate of the positive electrode layer, the solid electrolyte layer, and the negative electrode layer in the battery cell in the laminating direction.
When the pressing parts are provided on a pair of opposed surfaces, surface pressure can be applied from both sides in the laminating direction by sandwiching together the laminate of the positive electrode layer, the solid electrolyte layer, and the negative electrode layer in the battery cell.
In the present invention, it is preferable to provide the pressing parts on a pair of opposed surfaces.

FIG. 1 is a cross-sectional view of the solid-state battery according to the embodiment of the present invention.

In the solid-state battery 101 in FIG. 1, a pressing part 112 is provided on a surface that is substantially perpendicular to the laminating direction (illustrated by a double-headed arrow) of the laminate of the positive electrode layer, the solid electrolyte layer, and the negative electrode layer, in the battery cell 102.
In the solid-state battery 101 in FIG. 1, the pressing parts 112 are provided on a pair of opposed surfaces.

The structure of the pressing part is not particularly limited as long as it exhibits the action of applying surface pressure to the solid-state battery cell.

Examples thereof include a stepped shape, a corrugated shape, and a shape composed of a curved surface.

The solid-state battery 101 in FIG. 1 is an embodiment in which one-step stepped pressing parts 112 are provided.

The pressing part may be continuous or discontinuous in structure with a part other than the pressing part, in the battery case.

The discontinuous structure can exert another force together with the force of the spring.

The solid-state battery 101 shown in FIG. 1 is an embodiment in which one-step stepped pressing parts 112 are famed to be discontinuous with the battery case 103.

As in the present embodiment, if the pressing part is allowed to slide inwardly, for example, when the battery cell is pressed from both ends at the time of forming a solid-state battery module, the pressing part 112 slides and moves, making it easier to apply surface pressure to the battery cell.
Alternatively, when the internal pressure of the battery cell is increased, it is possible to release the stress to improve the safety.

In the pressing part inside the battery case, it is preferable to form one or more grooves serving as gas flow paths.

In the present invention, if the groove serving as a gas flow path is famed in the pressing part inside the battery case, it is possible to facilitate the transfer of gas when depressurizing the interior of the battery case by replacing and/or removing the gas in the battery case through the gas vent port.
Therefore, it is possible to depressurize the interior of the battery case efficiently, and to apply an initial load that results in sufficient surface pressure to the battery cell more efficiently, thus improving the output characteristics of the solid-state battery.

When a groove serving as a gas flow path is famed in the pressing part inside the battery case, the length of the groove is more preferably equal to or longer than the size of the solid-state battery cell.

If the length of the groove famed is equal to or longer than that of the solid-state battery cell, it is possible to apply pressure uniformly over the length direction of the battery cell.

In addition, it is more preferable that at least one of the grooves famed in the pressing part passes through a substantially central portion of the pressing part.

If the groove famed passes through the substantially central portion of the pressing part, the gas can pass through the substantially central portion of the battery cell, thus allowing pressure to be applied evenly to the battery cell.

Further, it is particularly preferable that at least two the grooves are formed and disposed substantially perpendicular to each other.

By forming the grooves so as to be disposed substantially perpendicular to each other, it is possible to apply an even load to a surface of the battery cell, thus improving the output characteristics of the solid-state battery.

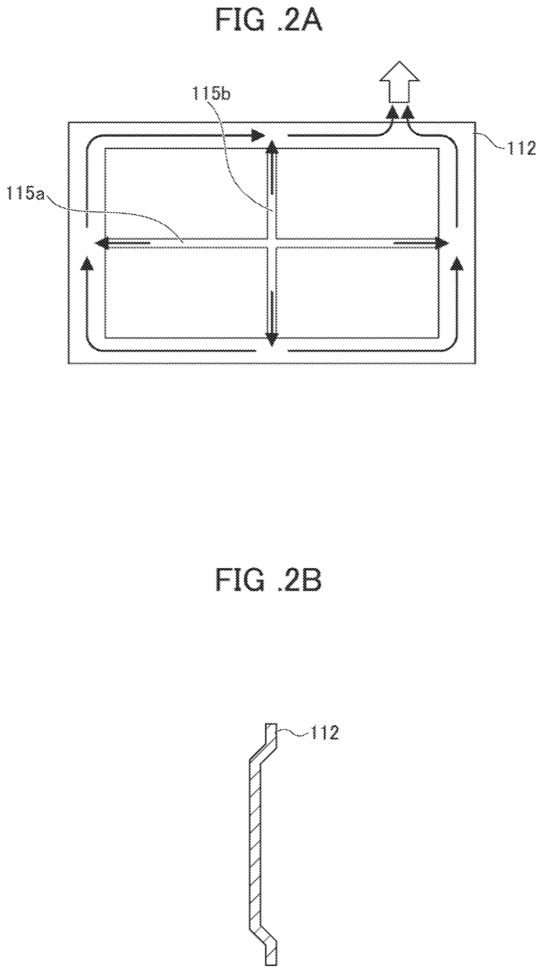

FIGS. 2A,2B and 3A,3B show a pressing part of a solid-state battery according to an embodiment of the present invention.

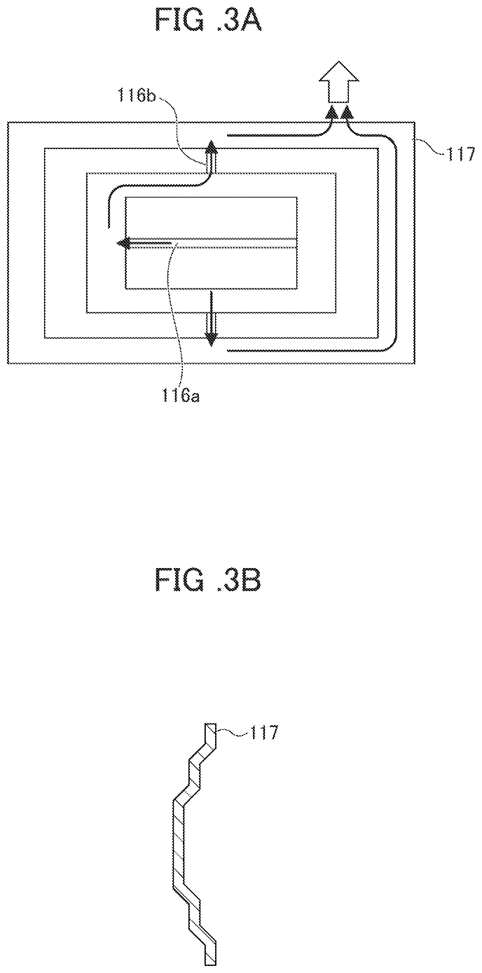

The pressing part 112 shown in FIGS. 2A and 2B are the pressing part 112 of the solid-state battery 101 according to the embodiment of the present invention shown in FIG. 1.
A pressing part 117 shown in FIGS. 3A and 3B are pressing parts according to another embodiment.

FIG. 2A is a view of the pressing part 112 of the solid-state battery 101 shown in FIG. 1 as seen from the inner side of the battery case 103, and FIG. 2B is a view of the pressing part 112 as seen from the side.

The pressing part 112 according to the embodiment has a one-step stepped shape.
Two grooves 115a and 115b are famed on the surface of the pressing part 112, which is the inner side of the battery case.

The two grooves 115a and 115b are respectively famed so as to penetrate vertically and horizontally through the surface of convex portion of the pressing part 112 and pass through the substantially central portion of the pressing part 112.

The two grooves 115a and 115b are disposed substantially perpendicular to each other in a cross shape.

In the pressing part 112 in FIGS. 2A and 2B, when the interior of the battery case is depressurized by replacing and/or removing gas through the gas vent port, the gas transfers as indicated by arrows. Specifically, the gas transfers from the vicinity of the center of the pressing part 112 to a region that is the periphery of the battery cell, transfers through the peripheral region and reaches the gas vent port, and then is discharged to the outside of the battery case.

FIG. 3A is a view of the pressing part 117 according to another embodiment as seen from the inner side of the battery case, and FIG. 3B is a view of the pressing part 117 as seen from the side.

The pressing part 117 according to the embodiment has a two-step stepped shape.
One groove 116a and a set of grooves 116b are famed on the surface of the pressing part 117, which is the inner side of the battery case.

The groove 116a is famed so as to horizontally penetrate the surface of the pressing part 117, which is the top of the convex portion, and to pass through a substantially central portion of the pressing part 117.

The set of grooves 116b are respectively famed so as to vertically penetrate the surface of the middle step of the convex portion of the pressing part 117.
The groove 116a and the set of grooves 116b are disposed substantially perpendicular to each other.

In the pressing part 117 in FIGS. 3A and 3B, when the interior of the battery case is depressurized by replacing and/or removing gas through the gas vent port, the gas transfers as indicated by arrows. Specifically, the gas transfers from the vicinity of the center of the pressing part 117 to a region that is the periphery of the battery cell through the groove 116a, then transfers along the middle step to enter the set of grooves 116b, transfers through the grooves 116b to a region that is the periphery of the battery cell, and then transfers to the gas vent port and is discharged to the outside of the battery case.

(Material)

The material of the battery case is not particularly limited, but is preferably metal.
When the material is metal, the heat dissipation is improved, the strength of the case itself can be improved, and metal welding is possible, and thus the sealing property is improved.

(Positive Electrode Layer and Negative Electrode Layer)

In the solid-state battery of the present invention, the positive electrode layer and the negative electrode layer which constitute the laminate serving as the solid-state battery cell are not particularly limited, and may be any layers which can be used as the positive electrode layer or the negative electrode layer of the solid-state battery.
The positive electrode layer and the negative electrode layer contain an active material and a solid electrolyte, and may optionally contain an electroconductive auxiliary agent, a binder, and the like.

As the materials of the positive electrode layer and the negative electrode layer which constitute the laminate serving as the solid-state battery cell, a material capable of constituting each electrode is selected. The charge-discharge electric potentials of the electrode materials are compared, and the material exhibiting a higher electric potential is used in the positive electrode layer, and the material exhibiting a lower electric potential is used in the negative electrode layer, to constitute any battery.

(Solid Electrolyte Layer)

In the solid-state battery of the present invention, the solid electrolyte layer constituting the laminate serving as the solid-state battery cell is not particularly limited, and any solid electrolyte layer may be used as long as it can be used as a solid electrolyte layer of a solid-state battery.
For example, a layer containing an oxide-based solid electrolyte or a sulfide-based solid electrolyte may be used.
Note that the composition ratio of the substances contained in the solid electrolyte layer is not particularly limited as long as the battery can be appropriately operated.
Further, the solid electrolyte layer may contain a binder or the like if necessary.

The solid electrolyte layer is disposed between the positive electrode layer and the negative electrode layer.

The thickness, shape, and the like of the solid electrolyte layer are not particularly limited as long as it is present between the positive electrode layer and the negative electrode layer and can conduct ions between the positive electrode layer and the negative electrode layer. Further, the making method is not particularly limited.

(Other Components)

The solid-state battery of the present invention may include a solid-state battery cell composed of a laminate including a positive electrode layer, a negative electrode layer, and a solid electrolyte layer; and a battery case that houses the solid-state battery cell, as essential components, and may include other components necessary for the solid-state battery.
Examples of the other components include a positive electrode tab and a negative electrode tab.

The positive electrode tab and the negative electrode tab are coupled to the current collecting foil of the positive electrode layer or the negative electrode layer, and collect current in the battery. The materials, structures, and the like of the positive electrode tab and the negative electrode tab are not particularly limited, and in the present invention, for example, a metal foil or the like having a thickness of about 5 to 500 μm can be used.

[Gap]

When a solid-state battery module is famed by disposing a plurality of the solid-state batteries of the present invention so as to be substantially parallel to one another in a given direction to form a solid-state battery module, the pressing parts of the solid-state battery form a gap between adjacent solid-state batteries.
The gap formed can increase the insulation and heat dissipation of the solid-state battery.

In the solid-state battery 101 according to the embodiment of the present invention shown in FIG. 1, the recess of the pressing part 112 of the battery case 103 forms a gap 111.

In the gap famed, it is preferable that at least one selected from the group consisting of a fluid such as air or water for suppressing the cell temperature, a heat transfer material, and a heater or the like, an electrical insulating material or an electrical conductive material for functioning the module, a buffer material, and a battery case fixing member or the like is present.

Method for Making Solid-State Battery>

The method for making a solid-state battery of the present invention is a method for making a solid-state battery including a solid-state battery cell and a battery case that houses the solid-state battery cell.

[Solid-State Battery]

The solid-state battery made by the method for making a solid-state battery of the present invention has the same configuration as that of the solid-state battery of the present invention described above.
The solid-state battery cell is a laminate including a positive electrode layer, a negative electrode layer, and a solid electrolyte layer present between the positive electrode layer and the negative electrode layer. The battery case includes a pressing part for applying surface pressure to the solid-state battery cell on a surface constituting the battery case, which is substantially perpendicular to the laminating direction of the laminate, and includes at least one gas vent port.

The method for making a solid-state battery of the present invention includes an enclosure step, a depressurization step, and a closure step, as essential steps.

[Enclosure Step]

The enclosure step is a step of enclosing the solid-state battery cell in the battery case.
In other words, this is a step of inserting a solid-state battery cell including a laminate including a positive electrode layer, a negative electrode layer, and a solid electrolyte layer presenting between the positive electrode layer and the negative electrode layer, and optionally other components into a battery case made of, for example, metal, and sealing the battery case.
The inserting and sealing method is not particularly limited, and a known method employed in methods for making a solid-state battery can be applied.

[Depressurization Step]

The depressurization step is a step of depressurizing the interior of the battery case by replacing and/or removing gas in the battery case through the gas vent port formed in the battery case.
By depressurizing the interior of the battery case, it is possible to apply an initial load that results in sufficient surface pressure to the battery cell, thus improving the output characteristics of the solid-state battery.

In the depressurization step, it is preferable to depressurize the interior of the battery case to a vacuum.

If the interior of the battery case reaches the state of vacuum, it is possible to apply the greatest surface pressure to the battery cell. As a result, depressurization to a vacuum can make the most significant contribution to improving the output characteristics of solid-state batteries.

In the depressurization step, when the interior of the battery case is depressurized by replacing gas in the battery case, the method is not particularly limited.

For example, the following method may be used: A three-way valve or the like with a vacuum pump or the like is connected to the gas vent port to discharge gas or the like in the remaining space through the vacuum pump, and then filling gas is supplied by switching the three-way valve.

Further, the type of gas to be replaced and filled is not particularly limited.

For example, dry air, nitrogen gas, and an inert gas such as argon gas or helium gas, can be used.
Among them, argon gas is preferable.

For example, when dry air is replaced with argon gas, the side reaction with a battery member in the case is suppressed, so that the durability is improved.

In the depressurization step, when the interior of the battery case is depressurized by removing gas in the battery case through the gas vent port, the method is not particularly limited.

For example, there is a method in which a vacuum pump or the like is connected to the gas vent port to suck out the gas in the battery case.

[Closure Step]

The closure step is a step in which the interior of the battery case is depressurized by the depressurization step, and then the gas vent port is closed by the closing member.
By closing the gas vent port, the depressurized state can be maintained, so that the output characteristics of the solid-state battery can be maintained for a longer period of time.

As the closing member for closing the gas vent port, the same as that used in the solid-state battery of the present invention described above is used.

The closing method is not particularly limited, and when the closing member is made of the same metal as that of the case member, for example, a closing method by welding may be used.

When the closing member is a sealing material, a sealing method suitable for the member can be selected as appropriate and applied.

[Other Step]

The method for making a solid-state battery of the present invention may optionally include an other step as long as it includes the above-mentioned enclosure step, depressurization step, and closure step. Examples of the other step include a heat pressurization treatment step of performing heating and pressurization.

It is known that the output characteristics of a solid-state battery are improved by heating and applying a load to the solid-state battery.

For this reason, in the method for making a solid-state battery of the present invention, it is preferable to perform a heat pressurization treatment step of performing heating and pressurization because the step can further improve the output characteristics.
The heat pressurization treatment step may be performed separately from the above-mentioned depressurization step, or may be performed simultaneously with the above-mentioned depressurization step, that is, the heating, depressurization, and pressurization may be simultaneously performed.

### EXPLANATION OF REFERENCE NUMERALS

101 solid-state battery
102 battery cell
103 battery case
104 positive electrode tab
109 negative electrode tab
111 gap
112 pressing part
113 remaining space

What is claimed is:

1. A method for making a solid-state battery comprising a solid-state battery cell and a battery case that houses the solid-state battery cell,
the solid-state battery cell being a laminate comprising a positive electrode layer, a negative electrode layer, and a solid electrolyte layer present between the positive electrode layer and the negative electrode layer,
a surface constituting the battery case that is substantially perpendicular to a laminating direction of the laminate, comprising a pressing part that applies surface pressure to the solid-state battery cell, and
the battery case comprising at least one gas vent port,
the method comprising:
an enclosure step of enclosing the solid-state battery cell in the battery case;
a depressurization step of depressurizing an interior of the battery case by replacing and/or removing gas in the battery case through the gas vent port; and
a closure step of closing the gas vent port with a closing member.

2. The method for making a solid-state battery according to claim 1, wherein the depressurization step evacuates the interior of the battery case.

3. The method for making a solid-state battery according to claim 1, wherein the closure step closes the gas vent port by metal welding or sealing with a sealing material.

4. The method for making a solid-state battery according to claim 1, further comprising a heat pressurization treatment step of performing heating and pressurization.
